(19) United States
(12) Patent Application Publication
(10) Pub. No.: US 2022/0396321 A1
(43) Pub. Date: Dec. 15, 2022

(54) FIFTH WHEEL SUPPORT STAND WITH WRAP

(71) Applicant: David Yager, Brentwood Bay (CA)

(72) Inventor: David Yager, Brentwood Bay (CA)

(21) Appl. No.: 17/342,742

(22) Filed: Jun. 9, 2021

(51) Int. Cl. B62D 63/08; B60P 3/32; B62D 63/06; B60S 9/04; B60D 1/60

(52) U.S. Cl. CPC B62D 63/08; B60P 3/32; B62D 63/062; B60S 9/04; B60D 1/60; B60J 11/06

(57) ABSTRACT

A recreational vehicle support stand that is configured to further provide indication of parameters such as but not limited to ownership, sports team affiliation or advertisements. The recreational vehicle support stand further includes a frame wherein the frame includes a plurality of vertical support members and horizontal support members. The frame is configured to support an end of a recreational trailer. The present invention further includes a cover member. The cover member is circumferentially disposed the frame extending between the top and bottom thereof. The cover member further includes a fastener that is operable to facilitate the removal or placement of the cover member on the frame. The cover member includes at least one pocket secured to the outer surface thereof. Various indicia may be imprinted on the outer surface of the cover member.

### FIELD OF THE INVENTION

The present invention relates generally to recreational vehicle accessories, more specifically but not by way of limitation, a fifth wheel trailer support stand wherein the fifth wheel trailer support stand further provides an exterior wrap operable to provide identification or a desired affiliation.

### BACKGROUND

In North America, recreational vehicles are immensely popular and are utilized by hundreds of thousands of people. There are several types of recreational vehicles that include but are not limited to small trailers, large recreational motor vehicles and larger trailers commonly known as fifth wheel trailers. All of the aforementioned are commonly utilized on vacations such as but not limited to camping excursions. Many times these recreational vehicles are parked in RV camps or similar campgrounds that offer hook-ups and provide a convenient place to park the RV during a trip or an extended stay.

One opportunity to improve the experience for recreational vehicles specifically for fifth wheel trailers is the ability to assist with identification or association of the owner of the fifth wheel trailer once the fifth wheel trailer has been parked and disconnected from the tow vehicle. As is known in the art, once disconnected from the tow vehicle, fifth wheel trailers are operably coupled to support stands. These support stands are typically tripod style frame that function to engage the portion of the trailer that is coupled to the fifth wheel hitch of the tow vehicle. While the conventional support stands function for their intended purpose, they have proven to provide no ancillary benefit. Campground organizers and managers often need assistance in identifying ownership of trailers that are temporarily visiting the campground. Additionally, there is opportunity for demonstration of brand or sports team loyalty that current support stands do not provide.

Accordingly, there is a need for a fifth wheel support stand that is configured to provide support of a fifth wheel trailer subsequent being disconnected from a tow vehicle wherein the present invention further includes a support surface for indicia directed towards identification, brand loyalty and other areas.

### SUMMARY OF THE INVENTION

It is the object of the present invention to provide a fifth wheel support stand that is configured to provide support of a fifth wheel trailer subsequent being disconnected from a tow vehicle wherein the present invention includes a frame.

Another object of the present invention is to provide a recreational trailer support stand operable to support an end of a recreational trailer wherein the frame of the present invention includes three support members forming a tripod configuration.

A further object of the present invention is to provide a fifth wheel support stand that is configured to provide support of a fifth wheel trailer subsequent being disconnected from a tow vehicle wherein the frame includes a cover member.

Still another object of the present invention is to provide a recreational trailer support stand operable to support an end of a recreational trailer wherein the cover member is configured to circumferentially surround the frame.

An additional object of the present invention is to provide a fifth wheel support stand that is configured to provide support of a fifth wheel trailer subsequent being disconnected from a tow vehicle wherein the cover member extends between the top and bottom of the frame.

Yet a further object of the present invention is to provide a recreational trailer support stand operable to support an end of a recreational trailer wherein the cover member further includes an integrated pocket formed thereon.

An additional object of the present invention is to provide a fifth wheel support stand that is configured to provide support of a fifth wheel trailer subsequent being disconnected from a tow vehicle wherein the cover member is configured to be adjustable in height so as to accommodate a frame when the frame is in an extended or a more compressed position.

Another object of the present invention is to provide a fifth wheel support stand that is configured to provide support of a fifth wheel trailer subsequent being disconnected from a tow vehicle wherein the cover member includes an outer surface having indicia imprinted thereon.

Still an additional object of the present invention is to provide a recreational trailer support stand operable to support an end of a recreational trailer wherein the cover member includes a fastener extending from the lower edge to the top edge to facilitate the placement and removal thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a support stand with cover member 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

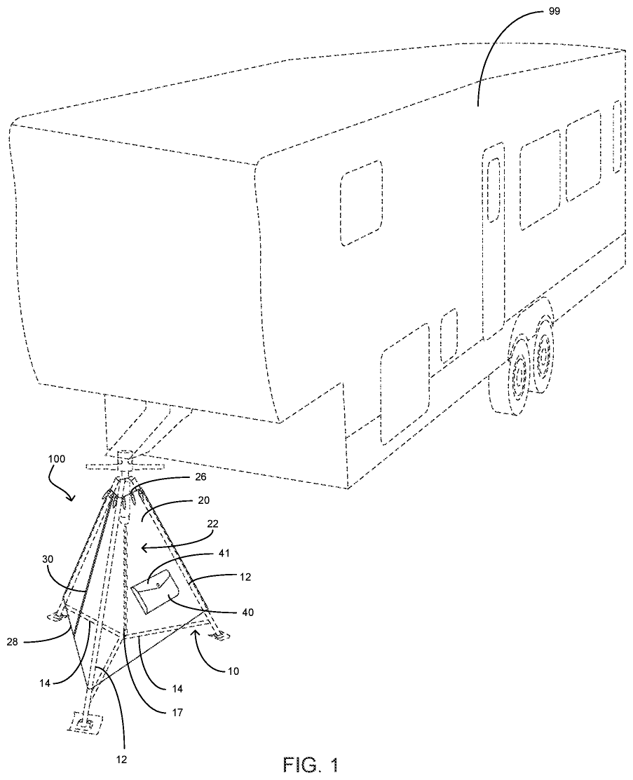

Referring in particular the FIGURE submitted as a part hereof, the support stand with cover member 100 includes a frame 10. The frame 10 is manufactured from a suitable material such as but not limited to metal. The frame 10 includes vertical support members 12 and horizontal support members 14 that are movably coupled in order to transition the frame 10 between an open position and a closed position. In FIG. 1 submitted herewith the frame 10 is in the open position so as to provide support for the exemplary recreational trailer 99. The frame includes three vertical support members 12 and three horizontal support members 14. A center support member 17 is also present to provide the necessary structural integrity for the frame 10. While a tripod design is illustrated herein for the support stand with cover member 100, it should be understood within the scope of the present invention that the frame 10 could employ alternate quantities of support members in order to create a frame 10 having alternate shapes and sizes.

The support stand with cover member 100 includes a cover member 20 operably coupled to the frame 10. The cover member 20 is surroundably mounted to the frame 10. The cover member 20 is formed in a mateable shape as the frame 10 and is removed and installed utilizing a fastener 30. The fastener 30 extends from the lower edge 28 of the cover member 20 to the upper edge 26 of the cover member 20. In a preferred embodiment of the support stand with cover member 100, a zipper is utilized for the fastener 30. While a zipper is utilized in the preferred embodiment for the fastener 30, it is contemplated within the scope of the present invention that the fastener 30 could be alternate types of mechanical fasteners.

The cover member 20 includes an outer surface 22. While not particularly illustrated herein, it is contemplated within the scope of the present invention that the outer surface 22 could have many alternate types of indicia printed thereon. By way of example but not limitation, the outer surface 22 could have printed thereon, an owner's name, sports team, club affiliation or other types of branding material.

Secured to the cover member 20 utilizing suitable durable techniques is a pocket 40. Pocket 40 includes flap member 41 that is configured to provide opening and closing of the pocket 40. The pocket 40 includes an interior volume and is configured to receive items therein such as but not limited to mail or notifications. It should be understood within the scope of the present invention that the pocket 40 could be provided in alternates sizes and shapes. Furthermore, it is contemplated within the scope of the present invention that the support stand with cover member 100 could include more than one pocket 40 placed in alternate locations on the cover member 20.

While the frame 10 has been included herein, it should be understood within the scope of the present invention that the cover member 20 could be provided so as to surroundably mount an existing frame wherein that existing frame could be provided in alternate shapes and sizes with the cover member 20 being mateable therewith. While not particularly illustrated herein, it is further contemplated within the scope of the present invention that the cover member 20 could have light assemblies releasably secured thereto utilizing fasteners such as but not limited to hook and loop fasteners. Additionally, it is contemplated within the scope of the present invention that the cover member 20 could have at least one integrated magnet sewn therein in order to facilitate the ability to place metal signs or the like onto the cover member.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A cover for a recreational vehicle support stand wherein the cover comprises:
a cover member, said cover member having a body, said cover member having a lower perimeter edge and an upper perimeter edge, said cover member having an outer surface, said cover member configured to be surroundably mounted the recreational vehicle support stand; and
wherein said outer surface of said cover member includes indicia imprinted thereon.

2. The cover for a recreational vehicle support stand as recited in claim 1, and further including at least one pocket, said at least one pocket being secured to said outer surface of said cover member.

3. The cover for a recreational vehicle support stand as recited in claim 2, wherein said at least one pocket further includes a flap member, said flap member configured to provide access to an interior volume of said at least one pocket.

4. The cover for a recreational vehicle support stand as recited in claim 3, and further including a fastener, said fastener configured to extend between said lower perimeter edge and said upper perimeter edge of said cover member, said fastener operable to provide securing and removing of said cover member to the recreational vehicle support stand.

5. The cover for a recreational vehicle support stand as recited in claim 4, wherein said fastener is manufactured from a zipper.

6. A recreational vehicle support stand that is operable to provide identification of association or ownership wherein the recreational vehicle support stand comprises:
a frame, said frame including a plurality of vertical support members, said frame further including a plurality of horizontal support members, said frame being movable intermediate a collapsed position and an open position, said frame configured to provide support for an end of a recreational vehicle, said frame being manufactured from metal;
a cover member, said cover member configured to be circumferentially disposed around said frame, said cover member having a body, said cover member having a lower perimeter edge and an upper perimeter edge, said cover member having an outer surface; and
wherein said outer surface of said cover member includes indicia imprinted thereon.

7. The recreational vehicle support stand as recited in claim 6, and further including a fastener, said fastener configured to extend between said lower perimeter edge and said upper perimeter edge of said cover member, said fastener operable to provide securing and removing of said cover member to the recreational vehicle support stand.

8. The recreational vehicle support stand as recited in claim 7, wherein said fastener is manufactured from a zipper.

9. The recreational vehicle support stand as recited in claim 8, and further including at least one pocket, said at least one pocket being secured to said outer surface of said cover member.

10. The recreational vehicle support stand as recited in claim 9, wherein said at least one pocket further includes a flap member, said flap member configured to provide access to an interior volume of said at least one pocket.
